(19) United States
(12) Patent Application Publication
(10) Pub. No.: US 2002/0016958 A1
(43) Pub. Date: Feb. 7, 2002

(54) Remotely controlled program operation

(76) Inventors: Dirk Formhals, Frankfurt (DE); Yvonne Stockle, Obertshausen (DE)

Correspondence Address: HARNESS, DICKEY & PIERCE, PLC, P.O. BOX 828, BLOOMFIELD HILLS, MI, 48303, US

(21) Appl. No.: 09/843,529

(22) Filed: Apr. 26, 2001

(30) Foreign Application Priority Data
May 11, 2000 (DE) 100 22 907.7-53

(51) Int. Cl. G06F 9/44

(52) U.S. Cl. 717/167

(57) ABSTRACT

A method of controlling an application program that communicates information over a network (32) between a client (34) and a server (20) is provided. The application program has a previous state and a current state. At least two methods (24) are stored on the server (20). At the server (20), a request having a state indicator indicative of the previous state of the application program is received. One of the methods (24) is selected based upon the state indicator. Then, the requested method (24) is transmitted to the client (34).

### BACKGROUND OF THE INVENTION

1. Field of the Invention

The present invention relates to the operational control of computer programs running on a client that is connected to a server via a data connection.

2. Description of the Related Art

With the introduction of the World Wide Web and its preferred protocol HTTP, the HTML page description language, and the general availability of browsers for viewing HTML documents sent via data connections using HTTP, it has become popular to program applications on this basis. The JAVA object-oriented programming language is particularly interesting in this context, since an application program called an applet can be contained in an HTML page, and loaded from a server onto a client and executed there. This applet generally uses objects from classes that are already present on the client, and which are dynamically loaded and linked via import mechanisms. By installing the appropriate class libraries on the client, it is therefore possible to provide application programs that are capable of controlling devices, as in the case of self-service terminals and cash dispensers in particular. This means that it is possible to modularize the application program.

A non-trivial application, covering several HTML pages, therefore requires a set of JAVA applets. Each time the user moves to a different page, a further applet is loaded, and performs the operation associated with that page. The next page in each case can be referred to by means of hyperlinks that are explicitly encoded in the page concerned. Control lies implicitly with the user, who activates the relevant hyperlink.

However, this elementary form of controlling HTML applications is inadequate in the context of complex applications, where user input is managed, checked and analyzed by the relevant JAVA applet. Depending on the results, which may reflect the data entered and feedback from device controls, it is then necessary to branch to this or that program section. This can be initiated by the JAVA applet, where a new HTML page is loaded via an object provided by the browser. In this way, all operations are controlled entirely by applets.

However, the well-established advantage of ease of maintenance and compatibility is lost with this approach. If operational control takes place via hyperlinks that are activated by the user, then it is easy to adapt to the application concerned by linking the relevant pages with the associated applets in each case. It is not necessary to adapt the applets themselves, since these can be stored in class libraries that are changed relatively rarely, and which are also identical for different applications. This advantage is lost by transferring application control into the applets, since the corresponding applets would have to be modified for each variant, and a separate class library would have to be produced for each variant.

The objective of the invention is therefore to provide a solution, in which the same class libraries can be used for different variants of operations, and where the operations are nonetheless controlled entirely by the applets.

### SUMMARY OF THE INVENTION

A method of controlling an application program that communicates information over a network between a client and a server is provided. The application program has a previous state and a current state. At least two methods are stored on the server. At the server, a request having a state indicator indicative of the previous state of the application program is received. One of the methods is selected based upon the state indicator. Then, the requested method is transmitted to the client.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a shell program employed in a first embodiment in accordance with the principles of the invention;

FIG. 2 illustrates an HTML document employed in a first embodiment in accordance with the principles of the invention;

FIG. 3 illustrates a chain function employed in a first embodiment in accordance with the principles of the invention;

FIG. 4 illustrates a shell program that is used as a state function in a second embodiment in accordance with the principles of the invention;

FIG. 5 illustrates a Java class GetState employed in a second embodiment in accordance with the principles of the invention;

FIG. 6 illustrates an HTML page used for testing the GetState Java applet;

FIG. 7 illustrates an HTML document employed in a second embodiment in accordance with the principles of the invention;

FIG. 8 illustrates an executable function for modifying local program operation in accordance with the principles of the invention;

FIG. 9 illustrates an evaluation function for dynamic control;

FIG. 10 illustrates an HTML page that loads the executable and evaluation functions; and

FIG. 11 illustrates a presently preferred embodiment of a remotely controlled network based program.

### DETAILED DESCRIPTION OF THE PREFERRED EMBODIMENTS

The following description of the preferred embodiment(s) is merely exemplary in nature and is in no way intended to limit the invention, its application, or uses.

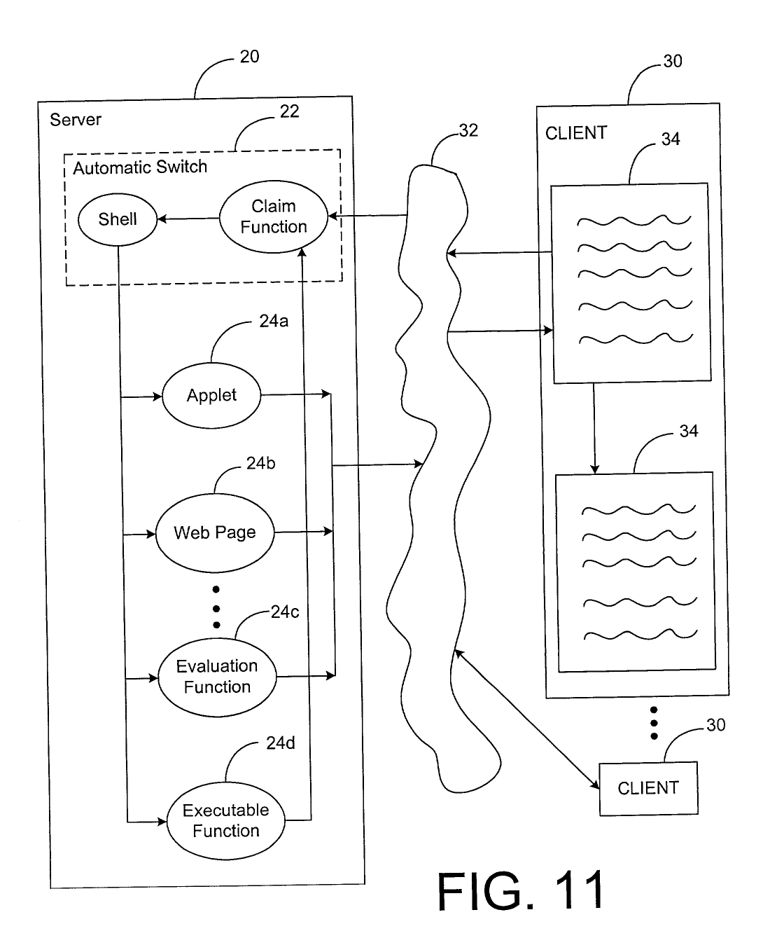

Referring to FIG. 11, a presently preferred embodiment of a server system 20 employing the remote control technique is illustrated. The technique consists of activating the next operation step from within a subroutine by means of specifying the activation step via a query from the server through the existing network. The server system 20 includes an automatic switch 22 for activating one of several methods 24. The methods include subroutines such as applets 24a, web pages 24b, executable functions 24c, and evaluation functions 24d.

The server 20 is coupled to one or more clients 30 through a network 32. Each client 30 preferably includes a Web browser for displaying information pages 34 received from the server 20.

Preferably, the automatic switch 22 is finite and may easily be represented by a table. This will become clear from the implementation examples described below. The code examples have been simplified considerably for the sake of clarity and, in some cases, also perform functions for which integrated resources are available. It is worth mentioning here that method calls in an object-oriented programming language such as JAVA are subroutine calls, in which a pointer to the occurrence of the relevant object is implicitly supplied as a parameter. In the context of inheritance, it may also be applicable to use a subroutine from another occurrence of another object, if the inheritance rules stipulate this.

Implementation Examples

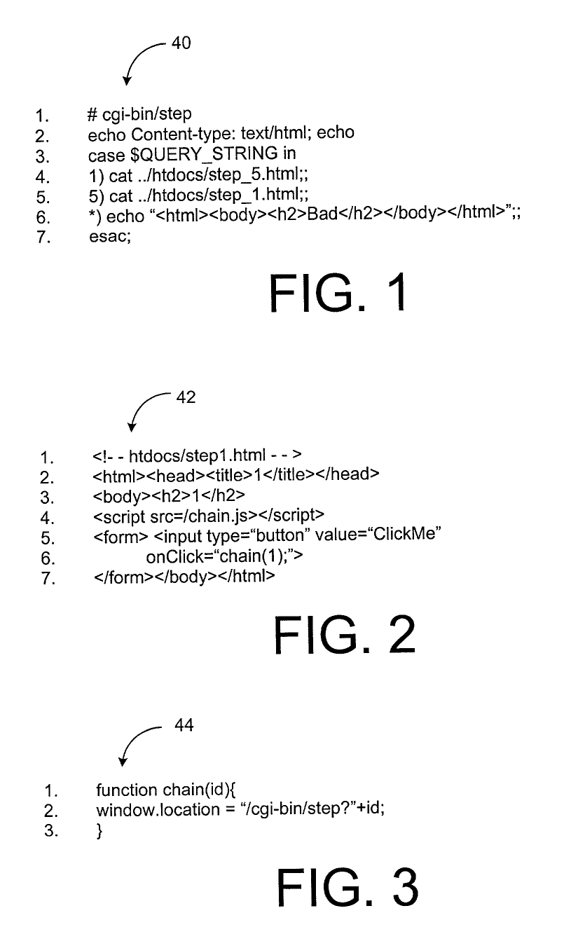

The programs listed in FIGS. 1 to 3 provide a considerably simplified implementation example. The line numbers are provided as reference markers and are not part of the program.

FIG. 1 is a shell program 40 that runs in the server as a CGI script. It is held as a file called “step” in the subdirectory “cgi-bin”, as is shown by the comment in Line 1.

FIG. 2 is an HTML document 42, which is held under the name “step1.html” in the root directory for HTML documents, as specified in the comment in Line 1. In this example, the widely used ‘apache’ server is used as an HTTP server, where “htdocs” is the standard directory for documents that are not specifically stored elsewhere, and “cgi-bin” is the standard directory for executable scripts.

FIG. 3 is a simple JAVASCRIPT “chain” function 44, which is stored in the root directory under “chain.js”.

Let us assume that the HTML document “step_{—}1.html” 42 shown in FIG. 2 and held on the server “host” is loaded into the client by means of the URL “http://host/stepl.html”, for example. As mentioned above, Line 1 is a comment. Line 2 contains the minimum tags required for an HTML document. The body text starts in Line 3, comprising the number 1 in this case, which represents part of the title line for Level 2. Line 4 loads the Javascript “chain” function, which is shown in FIG. 3 and explained below. Lines 5 and 6 contain an input field as part of a form, namely a button with the label “ClickMe”.

If this button is activated, then the previously defined “chain” function is called, as specified by the “onClick” parameter. The first and only parameter in this example is the name of the HTML page, namely the number “1”. The “chain” function 44 shown in FIG. 3 replaces the current HTML page with the page whose URL is made up from a fixed part “../cgi-bin/step?” and the parameter, i.e. the calling page. The shell script 40 from FIG. 1 is therefore called, and the data following the question mark is transferred to the global variable QUERY_STRING.

The shell script 40 shown in FIG. 1 generates a header in Line 2, which specifies that the following characters are an HTML document. A case distinction is used in Lines 3 to 7, to act differently according to the parameter in the QUERY_STRING variable. If the parameter is “1”, then the “cat” command outputs the HTML page “step_{—}5.html”, and vice versa the page “step_{—}1.html” if the parameter is “5”. Line 6 only defines an error code for unknown parameters.

For the sake of simplicity, the file “step_{—}5.html” (not shown) is identical to “step_{—}1.html”, except that the number “1” is replaced by the number “5” in Lines 1, 2, 3 and 6. This has the following effect: if the user clicks on the button when the page “step_{—}1.html” is loaded, then the page “step_{—}5.html” is activated, and vice versa. The invention simply shows that this sequence can be changed by modifying the case distinction in Lines 4 or 5 of FIG. 1. For example, if “step_{—}5.html” in Line 4 of FIG. 1 is replaced by “step_{—}7.html”, then this page will be presented to the user. This change is completely independent of the HTML text in FIG. 2.

In particular, a designer wishing to modify the graphical layout can change the HTML page without difficulty. He or she will not be aware of its operation, nor can the designer change its operation accidentally or on purpose.

The minimal version of the invention shown here can generally be improved by making the JAVASCRIPT function in FIG. 3 significantly more extensive, so that it checks the input and performs other additional processes before the next page is loaded from the server. Furthermore, the page that is called in each case normally already includes function calls as well as the function definitions in the loaded JAVASCRIPT program.

The implementation example described above still has the disadvantage that control flow takes place by means of changing HTML pages. A modified server is used to avoid this, and leave just a single sequence connection (also known as the state function) on the server. For the sake of simplicity and clarity, the HTTP protocol is also used for the server of the state function, so that the modified server is largely similar to that described above. In many application areas, a dedicated port with a TCP/IP connection is used for this purpose. As an alternative to the connection-oriented protocol TCP/IP, use of the datagram protocol UDP/IP is also effective, since each query can be handled in isolation and the data volumes are always very small. The only difference is in error handling, and this is not included in the examples provided in any case.

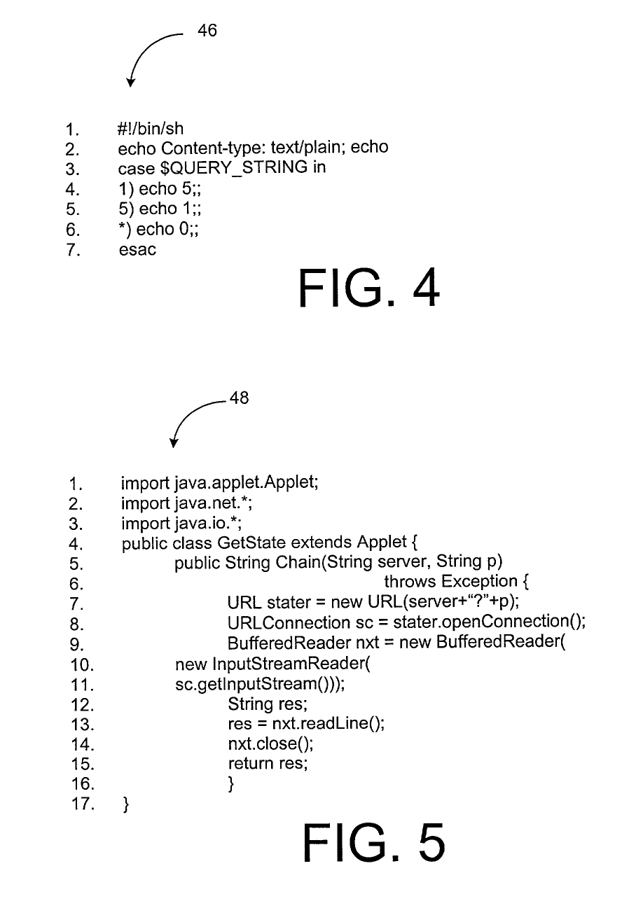

FIG. 4 provides a shell script 46 as an example, and this can be used as a state function for the server. Once again, it expects the previous state number as a parameter in QUERY_STRING, and implements the state function by means of a ‘case’ statement. Unlike the shell program of FIG. 1, however, simple text (‘text/plain’) is returned instead of an HTML document (‘text/html’). This consists solely of the number that identifies the next state. Once again, State 1 is converted to State 5 and vice versa.

However, due to security considerations when writing JAVASCRIPT, it is preferable to use JAVA in connection with the so-called ‘Live Connect’ component of the ‘Netscape Communicator’ browser, in order to interrogate the server in this variant of the invention. This component allows JAVA functions to be called from JAVASCRIPT.

FIG. 5 shows a corresponding JAVA class ‘GetState’ 48 with a single public function, namely ‘Chain’. This expects two parameters, namely the address of the server and the previous state. So that the ‘cgi-script’ shown in FIG. 4 can be used, the GET method of parameter transfer is applied once again, where the parameter is attached to the address by means of a question mark. This removes the need to program a write connection in FIG. 5, which would otherwise send the old state to the server as a parameter. In Line 7 of FIG. 5, the parameter is therefore added to the address of the server, and an HTTP connection is opened in Line 8. In order to make this example as clear as possible, error handling is effectively ignored by means of rerouting in the ‘throws’ clause at Line 6.

The next step is to set up the buffered reader ‘nxt’ for this connection in Lines 9 to 11, and the reply from the server is read into the variable ‘res’ in Line 13. After this, the connection can be closed. This result is then returned as the value of the function call.

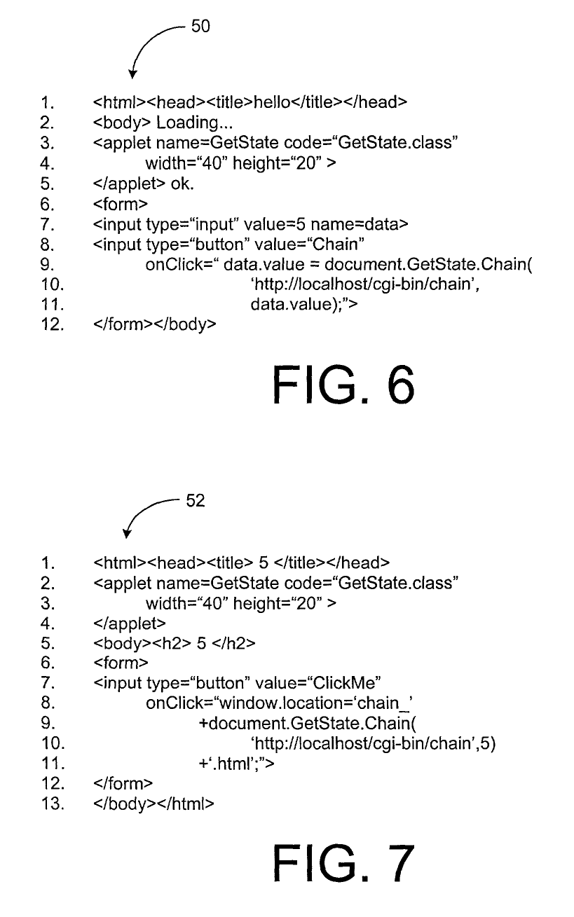

FIG. 6 shows an HTML page 50, in which the ‘GetState’ applet 48 is tested. The applet 48 is loaded in Lines 3-4, and offers the ‘Chain’ function described in FIG. 5 via the ‘Live-Connect’. The page mainly consists of a form with two elements, namely the ‘data’ input field defined in Line 7 and the button defined in Lines 8-11, which is not named. The button has an ‘onClick’ function, which replaces the content of the input field (i.e. ‘data.value’) with the value of the aforementioned ‘Chain’ function. Each time the button is clicked, the value is replaced by the next in accordance with the state function shown in FIG. 4. The first parameter, namely the URL of the state function according to FIG. 4, uses the computer name ‘localhost’ in the example, and this should be modified as appropriate.

FIG. 7 shows the structure of the page in FIG. 2 if the JAVA applet is used. This is loaded in Lines 2 to 4. The body of the resulting HTML page 52 comprises a form with a single button, which is defined in Lines 7 to 11. When the button is clicked, the current page is replaced by a page whose name is made up of the fixed prefix ‘chain_’ and the fixed postfix ‘.html’, located on either side of the result of the ‘Chain’ function call, which contains both the URL of the state function as its first parameter and the number of the old state (the page in this case) as its second parameter.

For testing purposes, the HTML page 52 shown in FIG. 7 is saved with the name “chain_{—}5.html”, and a copy is made with the name ‘chain_{—}1.html’ (not shown), in which the ‘5’ is replaced with a ‘1’. If the state function is expanded as per FIG. 4, then a corresponding number of pages should be set up. The selection of pages, which may be held on any server, is specified by the server defined in Line 10 of FIG. 7, specified as ‘localhost’ in the example.

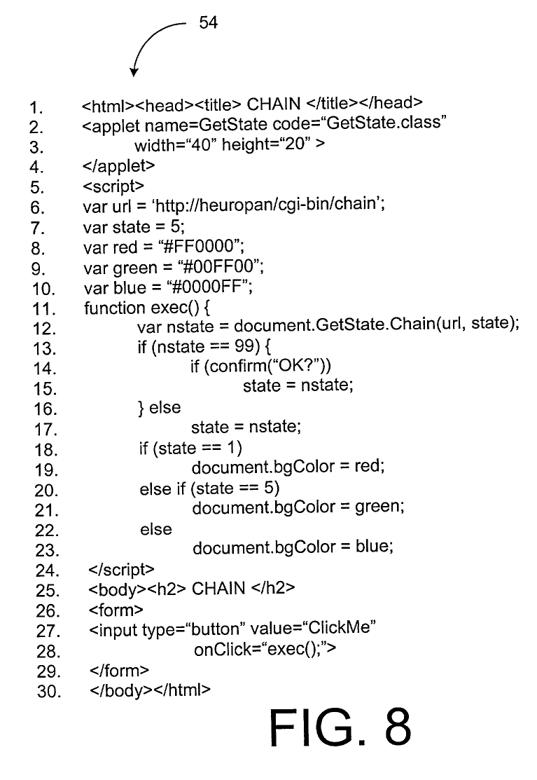

The example in FIG. 8, which has once again been radically simplified for the sake of clarity, shows how the result of the server query can be used to influence local program operation instead of loading a different document. In the local program control technique 54, the JAVA applet offering the ‘Chain’ function is once again loaded in Lines 2-3. Lines 5 to 24 show operational control consisting of an ‘exec’ function. Lines 25 to 30 show the body, consisting of a form with a single button (with the label ‘ClickMe’) and an ‘onClick’ result handler, which activates the ‘exec’ function each time the button is clicked.

Line 6 in FIG. 8 defines and pre-assigns the address of the state server in the ‘url’ variable, and Line 7 defines and pre-assigns the ‘state’ state variable. Three colour values are defined in Lines 8 to 10.

In Line 12, the new state ‘nstate’ is derived from the previous state ‘state’ when the ‘exec’ function is activated.

If this has a value of ‘99’, then the change in Line 14 is dependent on user confirmation, which would normally have to occur after Line 17. Lines 18 to 23 set the background colour depending on the ‘state’ state, and take the place of a complex operation.

Therefore, based on the application in FIG. 8, the sequence of background colours is determined by the server, which specifies this change via the ‘cgi-script’ ‘chain’.

Instead of the simple example shown above, it is now possible to implement a far more complex control sequence. In particular, the state function can accept complex parameters, where the present state does not just include the result of the last state change, but also a result from a current process. This is particularly useful in the context of user input or establishing the type of card that is currently inserted in a card reader. Access to the latter type of query normally takes place via JAVA class functions, which use recognized security measures to allow selective access to the computer's resources.

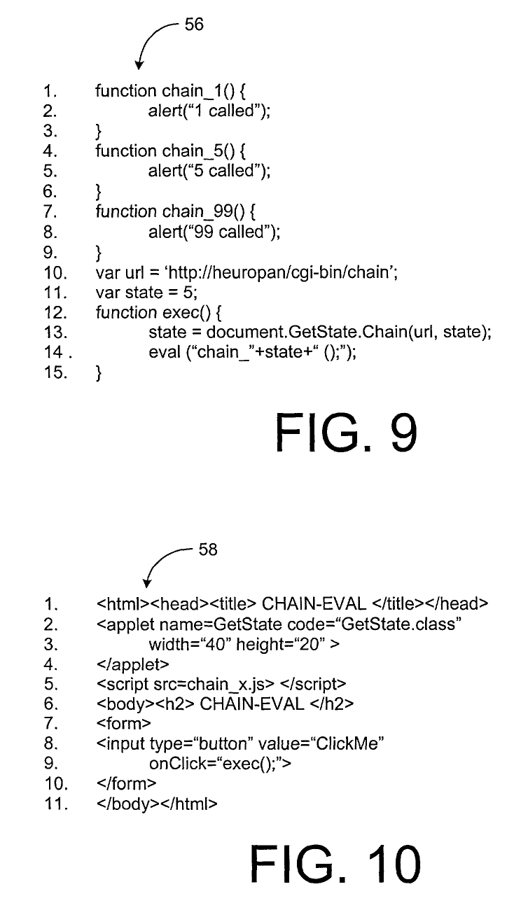

With the Javascript ‘eval’ function, the result can also be used to determine the name of the calling function dynamically. FIG. 9 shows a JAVASCRIPT program 56for dynamic control, with the ‘chain_1’ and ‘chain_5’ functions as well as the ‘exec’ function. FIG. 10 shows an HTML page 58, which loads the APPLET with the CHAIN function in Lines 2-4, loads the JAVASCRIPT program as per FIG. 9 in Line 5, and has, in Lines 7-11, a body like that in FIG. 8 Lines 20-25, which calls the ‘exec’ function each time the button is clicked.

This determines, absolutely in this instance, the new state from the old state with the ‘Chain’ function, and calls the corresponding function thus defined by means of the ‘eval’ function in Line 14 of FIG. 9. If necessary, the existence of this function can be verified by the ‘typeof’ operator, before loading the function dynamically, provided this is possible.

It is clear that JAVA programming could be used throughout instead of JAVASCRIPT, which is only used here by way of an example. In particular, the ‘Chain’ function is not then restricted to returning just a number, which is converted to a function name, but could also return a complete class designation with function name. Since dynamic class loaders are customary for JAVA, it is possible to make operation fully dynamic and definable from the host, and still run locally. In particular, such a dynamic class loader can also include cache functions, so that classes are only loaded if required over the existing network. In each case, the invention makes it possible to implement fully autonomous coding for the state transition.

Thus it will be appreciated from the above that as a result of the present invention a method and system for remotely controlling a program is provided by which the principal objectives, among others, are completely fulfilled. It will be equally apparent and is contemplated that modification and/or changes may be made in the illustrated embodiment without departure from the invention. Accordingly, it is expressly intended that the foregoing description and accompanying drawings are illustrative of preferred embodiments only, not limiting, and that the true spirit and scope of the present invention will be determined by reference to the appended claims and their legal equivalent.

What is claimed is:

1. A method for a computer application with operational control, in which overall operation is made up of sub-operations, by means of calling subroutines and methods of an object-oriented programming environment, comprising:
determining the next subroutine to be executed in each case by evaluating the result of a query that is sent via a data network.

2. The method as described claim 1 wherein the query includes the contents of a state variable.

3. The method as described in claim 1 wherein the query includes the result of one or more preceding functions.

4. The method as described in claim 1 wherein the subroutine or method is specified dynamically or loaded by a dynamic loader.

5. The method as described in claim 1 wherein the subroutine or the method is loaded via a data network.

6. A method of controlling an application program for communicating information over a network between a client and a server, the application program having a previous state and a current state, comprising:
storing at least two methods on the server;
at the server, receiving a request having a state indicator indicative of the previous state of the application program;
selecting one of the at least two methods based upon the state indicator; and
transmitting the requested method to the client.

7. The method of claim 6 wherein the step of selecting includes appending the state indicator to a shell identifier such that a unique one of the methods is identified.

8. The method of claim 7 wherein the step of selecting further includes selecting the unique one of the methods.

9. The method of claim 6 wherein the request is received from the client.

10. The method of claim 6 wherein the step of selecting includes input error checking.

11. The method of claim 6 wherein the at least two methods are selected from the group of applets, Web pages, executable functions, and evaluation functions.

12. The method of claim 6 wherein the state indicator is indicative of a calling function from which the request originated.

13. The method of claim 8 wherein a chain function appends the state indicator to the shell identifier.

14. A system for controlling an application program that communicates information over a network between a client and a server, comprising:
the server including a previous subroutine and at least two other subroutines;
an automatic switch, responsive to a client request having a designator indicative of the previous subroutine, to select one of the other subroutines based upon the designator; and
the server activating the selected subroutine.

15. The system of claim 14 wherein the subroutine is selected from the group of Web pages, applets, and functions.

16. The system of claim 14 wherein the automatic switch includes:
a chain function for appending the designator to a shell identifier such that a unique one of the subroutines is identified.

17. The system of claim 16 wherein the automatic switch further includes a shell for selecting the unique one of the subroutines.

18. The system of claim 16 wherein the automatic switch further includes an input error checker.

19. A method of controlling an application program for communicating information over a network between a client and a server, the application program having a previous state and a current state, comprising:
storing at least two methods on the server;
at the server, receiving a client request having a designator indicative of the previous state of the application program;
error checking the client request;
selecting one of the at least two methods based upon the designator;
appending the state indicator to a shell identifier such that a unique one of the methods is identified;
selecting the unique one of the methods based upon the state indicator; and
transmitting the requested method to the client.

20. The method of claim 19 wherein the at least two methods are selected from the group of applets, Web pages, executable functions, and evaluation functions.
